(19) United States
(12) Patent Application Publication
(10) Pub. No.: US 2016/0054571 A1
(43) Pub. Date: Feb. 25, 2016

(54) HEADSET HAVING VERSATILE EYE ORIENTATION ADJUSTMENT SYSTEM

(71) Applicants: Errol Mark Tazbaz, Bellevue, WA (US); Philip Andrew Frank, Kirkland, WA (US); Henric Jentz, Seattle, WA (US); Nicolas Denhez, Seattle, WA (US); Paul Bosveld, Seattle, WA (US); Aditha May Adams, Seattle, WA (US); Travis Justin Hosler, Seattle, WA (US)

(72) Inventors: Errol Mark Tazbaz, Bellevue, WA (US); Philip Andrew Frank, Kirkland, WA (US); Henric Jentz, Seattle, WA (US); Nicolas Denhez, Seattle, WA (US); Paul Bosveld, Seattle, WA (US); Aditha May Adams, Seattle, WA (US); Travis Justin Hosler, Seattle, WA (US)

(21) Appl. No.: 14/463,946

(22) Filed: Aug. 20, 2014

(51) Int. Cl. G02B 27/01

(52) U.S. Cl. CPC G02B 27/0176

(57) ABSTRACT

A headset is disclosed including optics supported on a headband by a pair of temple arm assemblies. The temple arm assemblies are positioned on either side of a wearer's head when the headset is worn. Each temple arm assembly may include one or more kinematic assemblies allowing pivotal and/or translational adjustment of the optics to optimize optical properties such as line-of-sight, pantoscopic tilt and/or eye relief. The one or more kinematic assemblies for each temple arm may have a variety of different pivots and/or slides enabling adjustment of the optics and optical properties.

### BACKGROUND

With a head-worn, augmented reality display device there is a need to produce imagery at a preferred location relative to the horizon, and a user orient's their eyes, up, down or straight ahead to view this content. The orientation of a user's eyes in viewing content (up, down or straight ahead) is referred to herein as line-of-sight. Line-of-sight preference is different across people and is also dependent on the type of content being interacted with. There is also a need to maintain the display device angle at a predefined angle with respect to the surface of the cornea. This optical property is referred to herein as pantoscopic tilt. There is also a need to be able to adjust the distance of the display device from the eyes. This optical property is referred to herein as eye relief.

### SUMMARY

The present technology relates to various embodiments of a headset including optics supported on a headband by a pair of temple arm assemblies. The temple arm assemblies are positioned on either side of a wearer's head when the headset is worn. Each temple arm assembly may include one or more kinematic assemblies allowing pivotal and/or translational adjustment of the optics to optimize optical properties such as line-of-sight, pantoscopic tilt and/or eye relief. The one or more kinematic assemblies for each temple arm may have a variety of different pivots and/or slides enabling adjustment of the optics and optical properties.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a side view of a headset including a headband and a head-worn device adjustably affixed to the headband according to an embodiment of the present technology.

FIG. 2 is a perspective view of a headband and kinematic assembly according to an embodiment of the present technology.

FIGS. 3-16 are side views of a headset including a headband and a head-worn device adjustably affixed to the headband according to further embodiments of the present technology.

### DETAILED DESCRIPTION

Embodiments of the present technology will now be explained with reference to the figures, which in general relate to various embodiments of a headset including optics and an adjustment system for quick and easy adjustment of the optics to an optimal position in front of a user's eyes. In embodiments, the optimal position may include optimizing a position of the optics with respect to a line-of-sight through the optics, a pantoscopic tilt of the optics and/or an eye relief of the optics.

The headset may include a headband having an around the head loop (referred to herein as a crown loop) which is generally horizontal when worn. The headset may additionally have an overhead loop in further embodiments which is generally vertical when worn. The optics may be supported on the headband via a pair of temple arms on opposite sides of the headband. Each temple arm may include one or more links. The links may be mounted to the headband by a kinematic assembly that allows pivoting and/or translation of the temple arms with respect to the headband.

Alternatively or additionally, multiple links in a temple arm may be mounted to each other by one or more kinematic assemblies allowing pivoting and/or translation of links with respect to each other within a temple arm. In embodiments, the temple arms may be mirror images of each other, each including the same configuration of links and kinematic assemblies. In further embodiments, it is conceivable that the temple arms not be mirror images of each other, each having a different configuration of links and/or kinematic assemblies.

The terms “top” and “bottom,” “upper” and “lower,” “vertical” and “horizontal” and “front” and “back” as may be used herein are by way of example and illustrative purposes only, and are not meant to limit the description of the invention inasmuch as the referenced item can be exchanged in position and orientation. Also, as used herein, the terms “approximately,” “substantially” and/or “about” mean that the specified dimension or parameter may be varied within an acceptable manufacturing tolerance for a given application. In one embodiment, the acceptable manufacturing tolerance is ±0.25%.

In embodiments described below, the optics of the headset may be a head mounted display (HMD) providing a virtual and/or augmented reality experience. In such embodiments, it is desirable that the optical properties such as line-of-sight, pantoscopic tilt and/or eye relief all be precisely controlled. This is accomplished by the various embodiments of the headset described below. In alternate embodiments, the optics may have other configurations, such as surgical loupes. In further embodiments, the optics may be replaced or supplemented with other head-worn devices, such as for example a light for headlamps or other types of head mounted devices.

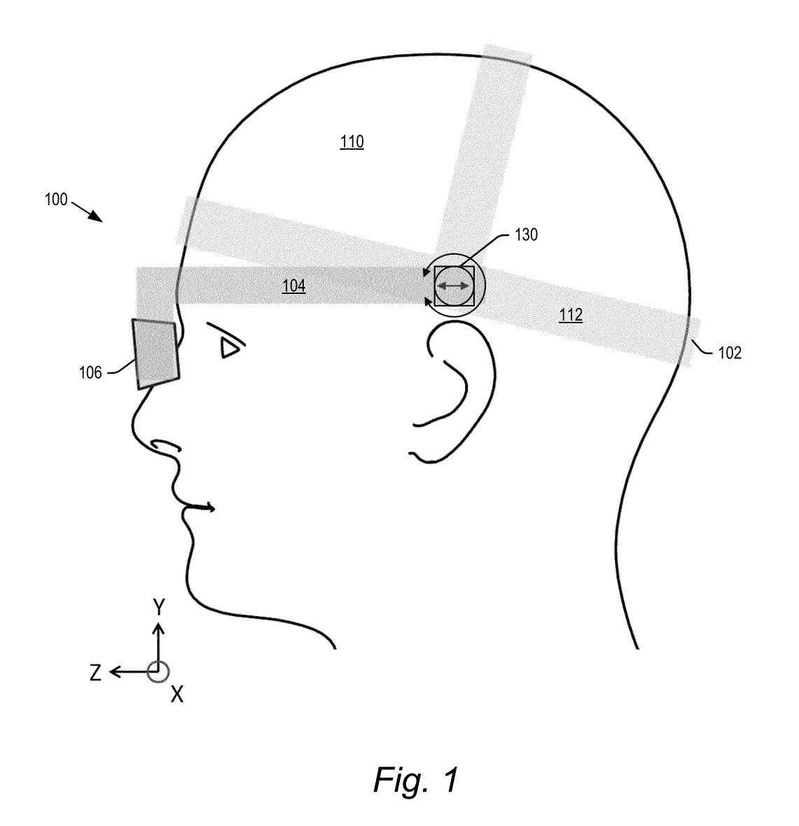

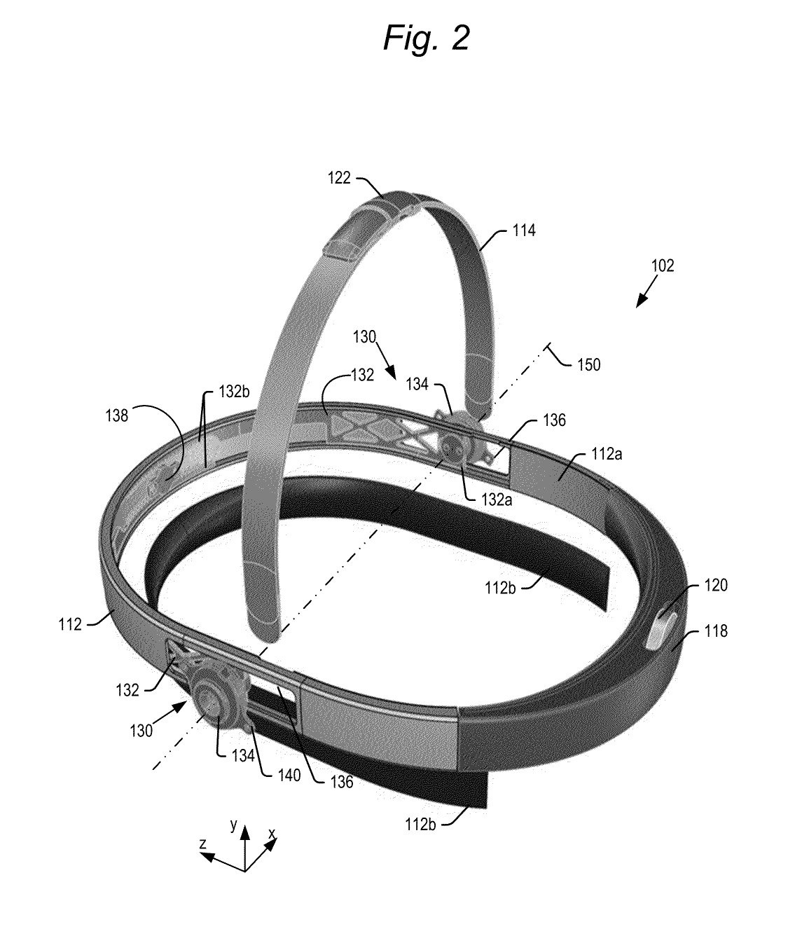

FIGS. 1 and 2 are side and perspective views of a first embodiment of a headset 100 having a headband 102 and a pair of temple arms 104. The temple arms connect at one end to the headband 102 and at their opposite ends to the optics 106 so as to support and variably adjust optics 106 with respect to the eyes of a wearer 110. At least some of FIGS. 1 and 3-16 show a single temple arm 104 and one of the optics 106 in side view. However, it is understood that the following description of one of the temple arms 104 and optics 106 applies to both temple arms and the pair of optics.

The headband 102 may include a crown loop 112 coupled to an overhead loop 114. In further embodiments, the headband 102 may include no overheard loop 114, or multiple overhead loops 114. As seen in FIG. 2, the crown loop 112 may have an adjustable diameter, such as for example by having ends which come together and overlap within a rear compartment 118. The ends may be adjustable with respect to each other via a crown adjustment mechanism. In one example, the adjustment mechanism may comprise a frictional clutch (not shown) within the rear compartment 118, which is operable by knob 120. The frictional clutch may be similar in design and operation to frictional clutch 138 shown in FIG. 2 and described below. The overhead loop 114 may also have an adjustable diameter, such as for example by having ends which overlap each other within an overhead adjustment mechanism 122.

The crown loop 112 may be comprised of semi-rigid members 112a, with an inner cushioning material 112b formed of soft material. The members 112a may be or include an elastic, semi-rigid material such as a plastic, or metal including for example aluminum or a shape memory alloy such as alloys of copper-aluminium-nickel. The cushioning material 112b may extend partially or completely around an interior (head-facing) portion of the crown loop 112 to provide a comfortable contact with the user's head 110. The cushioning material 112 may for example be or include polyurethane, a polyurethane foam, rubber or a plastic or other polymer. The cushioning material 112a may alternatively be or include fibers or fabric. Other materials are contemplated for both the semi-rigid member 112a and cushioning material 112b.

Referring again to FIG. 1, each temple arm 104 may be formed of any of a variety of rigid, lightweight materials, such as for example plastic, aluminum, polycarbonate or a variety of other materials. In the embodiment shown in FIG. 1, each temple arm 104 may be a link having a single unitary construction. As explained below, each temple arm may alternatively be formed of a plurality of links connected to each other via a kinematic assembly allowing pivoting and/or translation of the respective links. Where the temple arms are formed of a plurality of links, the temple arms 104 may be fixedly mounted on the headband 102 (i.e., connected in a way that prevents relative movement between the temple arms 104 and the headband 102). A single link or multi-link temple arm 104 may alternatively be pivotally or translationally mounted to the headband 102 in further embodiments.

As noted, the optics 106 may include left and right eye image generation and display assemblies for presenting stereoscopic images to the left and right eyes. In the embodiment of FIG. 1, the optics 106 may be fixedly mounted to the temple arms. In embodiments explained below, the optics 106 may be pivotally and/or translationally mounted on the temple arms 104 via a kinematic assembly 130 in each temple arm 104.

The temple arms 104 may be adjustably mounted to the headband 102 via a kinematic assemblies 130, one (or more) for each temple arm. Details of one configuration of a kinematic assembly 130 will now be explained with reference to FIG. 2. However, it is understood that a wide variety of alternative slides and/or pivots may be used in a kinematic assembly 130 to allow translation and/or pivoting of the temple arms 104 relative to the headband 102. As explained in the various embodiments below, a kinematic assembly may be provided at at least one junction between the headband 102 and a link in the temple arm 104, between two links of the temple arm 104, and/or between a link in the temple arm 104 and optics 106.

Each kinematic assembly 130 may include a slide 132 mounted for translation within a track formed in a front portion of the crown loop 112. Each slide 132 includes a first end 132a supporting a pivot assembly 134 in a slot 136 for linear translation along the slot 136. A second end 132b of each slide 132 may engage a frictional clutch 138. In particular, each of the second ends 132b of the two slides 132 may have teeth for engaging the top and bottom edges, respectively, of a gear within the frictional clutch 138. Thus, the pair of slides 132 are constrained to translate with each other in unison forward and back within the slots 136 upon rotation of the frictional clutch 138.

Each pivot assembly 134 may include a base that is stationarily mounted to the slide 132, and a hub that is pivotally mounted to the base. Each hub may include a pair of mounting brackets 140 (one of which is numbered in one of the kinematic assemblies 130 shown in FIG. 2). Each temple arm 104 may include a front section positioned adjacent optics 106 and a rear section affixed to the mounting brackets 140 to affix the head-worn device to the temple arms 104 to the headband 102.

The pivot assemblies 134 allow the temple arms of FIGS. 1 and 2 to pivot about an x-axis through a desired angle to adjust the optics 106 to a desired position over a user's eyes, or otherwise at the front of a user's face. This allows adjustment of the line-of-sight through the optics 106. As the pivot assemblies 134 are mounted for translation on slides 132 in slots 136, the temple arms 104 and optics 106 may also be moved linearly along the z-axis nearer to or farther from the user's face. This allows adjustment of the eye relief of the optics 106. The embodiment of FIGS. 1 and 2 may include two degrees of freedom, pivoting about a single x-axis and translation along a single z-axis. Embodiments described below have greater degrees of freedom.

In embodiments, the pivot assemblies 134 and the frictional clutch 138 may be configured to resist pivoting and translation, respectively, of the temple arms 104 and optics 106 so that, once manually adjusted by a user, the optics 106 remain in the set position. In one example, the pivot assemblies 134 and the frictional clutch 138 may effectively resist movement of the temple arms 104 and optics 106 for exerted threshold forces less than 3 g. This may be done by providing sufficiently high forces of static friction between moving parts in the pivot assembly 134 and frictional clutch 138. This may additionally and/or alternatively be done by providing a number of detents on one side and one or more bumps on another side of parts that move against each other. This arrangement defines a number of preset positions into which the pivot assembly 134 and frictional clutch are biased. Once in a detent, the pivot assembly 134 and frictional clutch resist movement out of the detent until a threshold force (of for example 3 g) is exerted. It is understood that the pivot assemblies 134 and/or frictional clutch 138 may prevent movement for threshold forces which are lesser or greater than 3 g in further embodiments.

In embodiments of a kinematic assembly described above, slide 132 is mounted to the headband 102, and the pivot assembly 134 is mounted to the slide 132. In further embodiments, mounting of a kinematic assembly may be reversed, so that the slide 132 may be mounted within a slot 136 formed in a temple arm 104. In such embodiments, the pivot assembly 134 of the kinematic assembly 134 may then be affixed onto the headband 102.

A variety of pivotal and/or translational couplings are described hereinafter. Each such coupling may be accomplished by a kinematic coupling 130 as described above. In some embodiments, a kinematic assembly 130 may allow only pivoting of the connected components. Such kinematic couplings are referred to as kinematic couplings 130a. In some embodiments, a kinematic assembly 130 may allow only translation of the connected components. Such kinematic couplings are referred to as kinematic couplings 130b.

Where a kinematic coupling 130b is provided in each temple arm 104, each such kinematic coupling may include a frictional clutch 138 engaging end 132b of a single slide 132 (instead of the clutch 138 engaging ends 132b of both slides 132). In further embodiments noted below, a translating kinematic coupling 130b may be comprised simply of telescoping sections that slide relative to each other. In such embodiments, the slide 132 and frictional clutch 138 may be omitted.

FIG. 1 illustrates the temple arms mounting an approximate midpoint, front to back, on the crown loop 112. However, it is understood that the temple arms 104 may affix to either the crown loop 112 or overhead loop 114 at different locations. As explained below, in embodiments, instead of temple arms, the optics 106 may be supported by a bracket mounted at or toward a front portion of the crown loop 112.

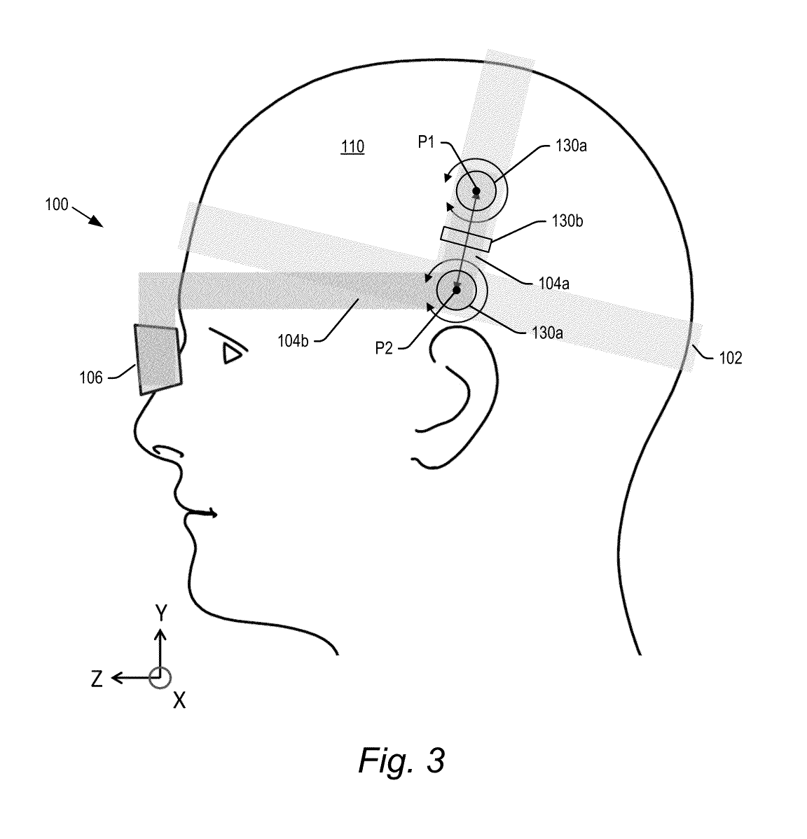

FIG. 3 shows a further embodiment of headset 100 including optics 106 mounted to headband 102 via temple arms 104 each including links 104a, 104b and kinematic assemblies 130a, 130b. In particular, a link 104a may be pivotally mounted by kinematic assembly 130a to the headband 102 at a point P1. The link 104a may be pivotally mounted by kinematic assembly 130a to the link 104b a point P2. Further, link 104a may include a kinematic assembly 130b to allow translation of the point P2 toward and away from point P1. Toward this end, link 104a may include a pair of telescoping sections so that the length of link 104a can change. Optics 106 may be fixedly mounted to the link 104b.

The headset 100 of FIG. 3 allows adjustment of the optics 106 with three degrees of freedom. The two kinematic assemblies 130a allow rotation of the optics 106 about two distinct x-axes (at points P1 and P2), and the kinematic assembly 130b allows translation of the temple arm 104 in the y-z plane. Rotation at point P1 will rotate links 104a, 104b, point P2 and optics 106 relative to the headband 102. Translation of kinematic assembly 130b will translate a lower portion of link 104a, link 104b, point P2 and optics 106 relative to an upper portion of link 104a. And pivoting at point P2 will pivot link 104b and optics 106 relative to link 104a.

The kinematic assemblies and links of the temple arms 104 in FIG. 3 allow adjustment of the line-of-sight, pantoscopic tilt and eye relief of optics 106. Adjustment of one of these optical properties may have a ripple effect on others of these properties. A user may make adjustments to kinematic assemblies 130 and temple arms 104 to converge on a solution where the line-of-sight, pantoscopic tilt and eye relief are all optimized to the use's preference. The configuration of FIG. 3 may be modified in further embodiments so that the kinematic assembly 130a at point P2 or the kinematic assembly 130b may be omitted.

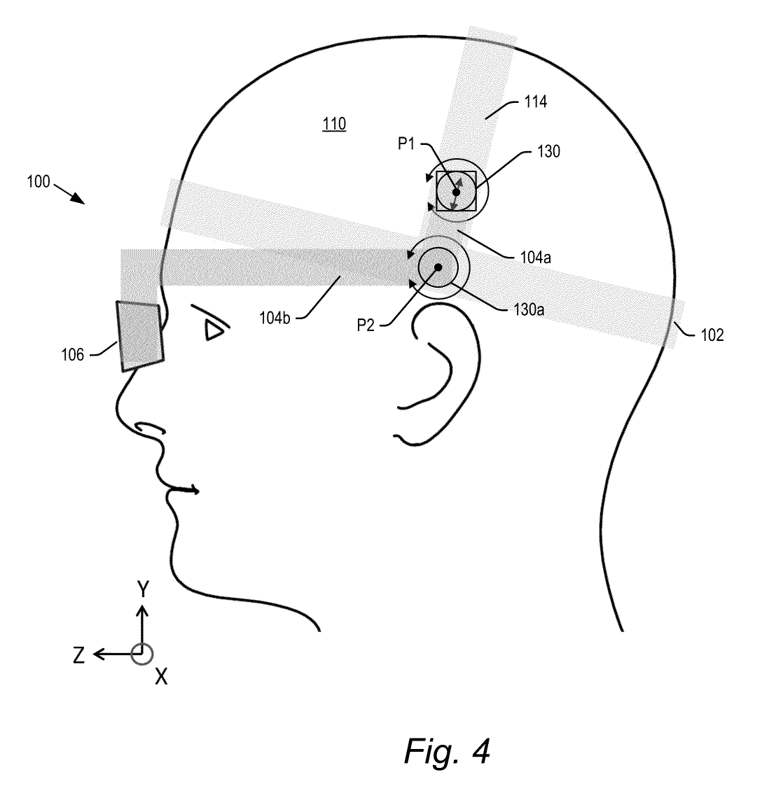

FIG. 4 shows a further embodiment of headset 100 including optics 106 mounted to headband 102 via temple arms 104 each including links 104a, 104b and kinematic assemblies 130 and 130a. FIG. 4 is similar to the embodiment of FIG. 3, with the modification that, instead of the link 104a having a kinematic assembly 130b with telescoping sections so that the length of 104a can change, the link 104a is of unitary construction with a constant length. The translating kinematic assembly 130b has instead been combined into the kinematic assembly at point P1 (making it a translating and pivoting kinematic assembly 130). In this embodiment, the kinematic assembly 130 at point P1 is mounted to the overhead loop 114. Thus, the optics 106 and the entire temple arm 104 (including links and kinematic assemblies) may pivot and translate with respect to the headband 102 at point P1. The embodiment of FIG. 4 is similar in other respects to the embodiment of FIG. 3 described above.

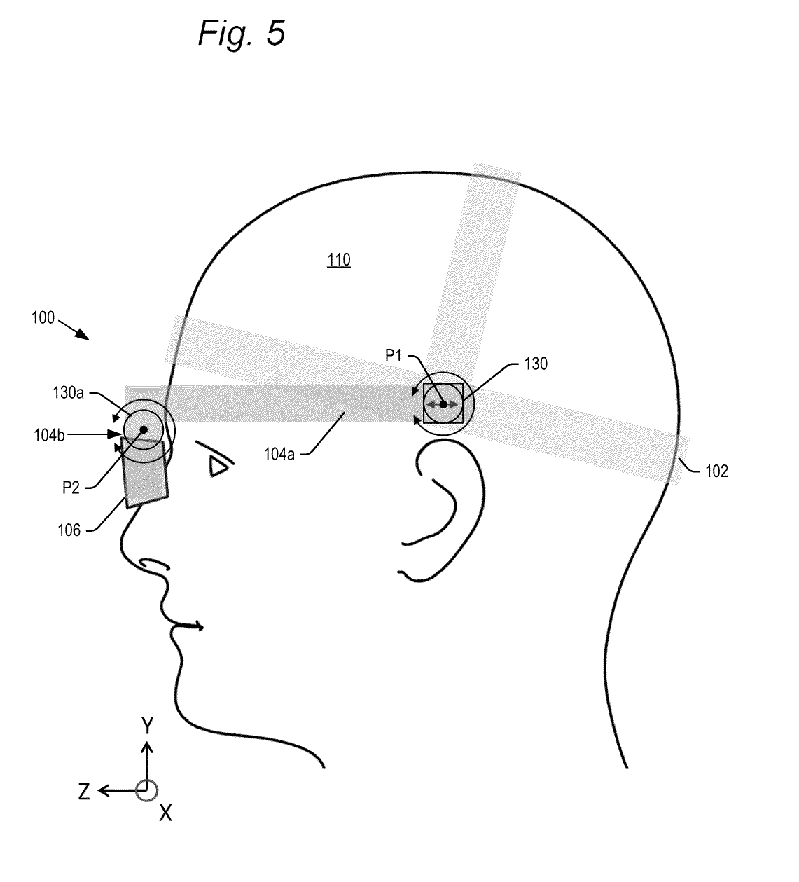

FIG. 5 shows a further embodiment of headset 100 including optics 106 mounted to headband 102 via temple arms 104 each including links 104a, 104b and kinematic assemblies 130 and 130a. In this embodiment, a link 104a is an “L” shaped link pivotally and translationally mounted by kinematic assembly 130 to the headband 102 at a point P1. A further kinematic assembly 130a pivotally mounts the optics 106 and a short link 104b (below the kinematic assembly 130a) to link 104a at point P2. In further embodiments, the links 104a and 104b may comprise a single link of unitary construction, and the kinematic assembly 130a may be provided at the end of the link, between the link and the optics 106.

The headset 100 of FIG. 5 allows adjustment of the optics 106 with three degrees of freedom. The kinematic assemblies 130, 130a allow rotation of the optics 106 about two distinct x-axes (at points P1 and P2), and the kinematic assembly 130 further allows translation of the temple arm 104 in the y-z plane. Rotation at point P1 will rotate links 104a, 104b, point P2 and optics 106 relative to the headband 102. Translation at point P1 will translate links 104a, 104b, point P2 and optics 106 relative to the headband 102. And pivoting at point P2 will pivot link 104b and optics 106 relative to link 104a. The kinematic assemblies and links of the temple arms 104 in FIG. 5 allow adjustment of the line-of-sight, pantoscopic tilt and eye relief of optics 106.

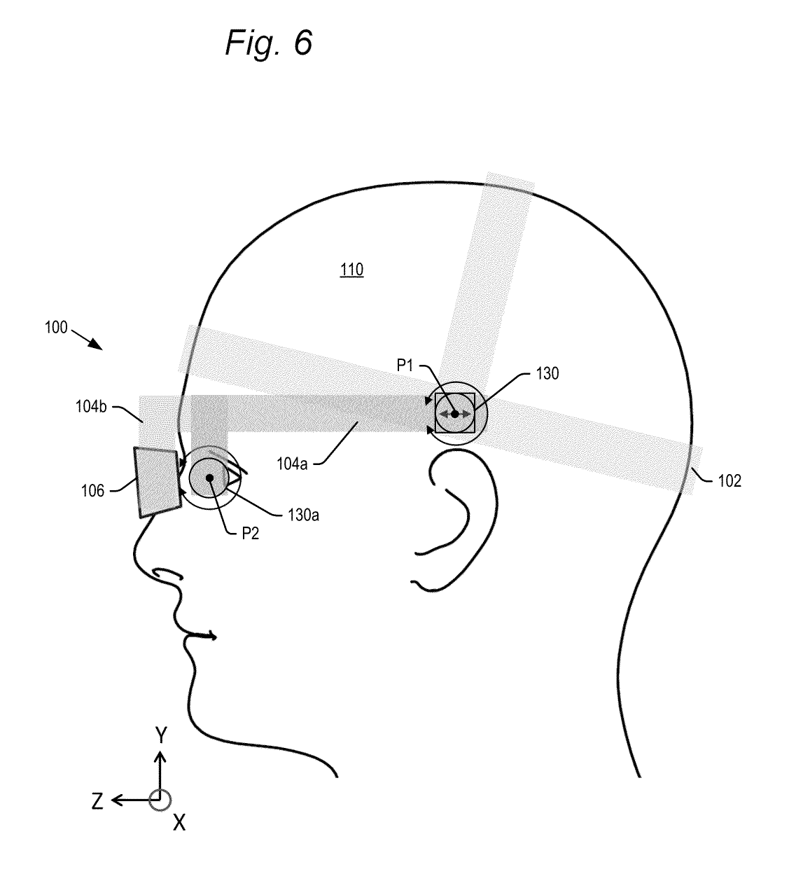

FIG. 6 shows a further embodiment of headset 100 including optics 106 mounted to headband 102 via temple arms 104 each including links 104a, 104b and kinematic assemblies 130 and 130a. In this embodiment, a link 104a is an “L” shaped link pivotally and translationally mounted by kinematic assembly 130 to the headband 102 at a point P1. An upside down “U” shaped link 104b may be pivotally mounted to the link 104a at point P2 by kinematic assembly 130a. The optics 106 may be fixedly mounted on the link 104b.

The links 104b may lie in different y-z planes (into and out of the page of FIG. 6) so that the link 104b may freely pivot with respect to link 104a without the downwardly extending portions of links 104a, 104b adjacent to point P2 conflicting with each other. In one embodiment, the distance between the links 104b on the pair of temple arms 104 on opposed sides of the head of wearer 110 may be greater than the distance between the links 104a on the pair of temple arms 104.

The headset 100 of FIG. 6 allows adjustment of the optics 106 with three degrees of freedom. The kinematic assemblies 130, 130a allow rotation of the optics 106 about two distinct x-axes (at points P1 and P2), and the kinematic assembly 130 further allows translation of the temple arm 104 in the y-z plane. Rotation at point P1 will rotate links 104a, 104b, point P2 and optics 106 relative to the headband 102. Translation at point P1 will translate links 104a, 104b, point P2 and optics 106 relative to the headband 102. And pivoting at point P2 will pivot link 104b and optics 106 relative to link 104a. The kinematic assemblies and links of the temple arms 104 in FIG. 6 allow adjustment of the line-of-sight, pantoscopic tilt and eye relief of optics 106. The downwardly extending portions of links 104a, 104b place the point P2 at the elevation of the eyes of wearer 110, to facilitate adjustment of the optical properties. For example, placing the point P2 at the elevation of the user's eyes allows adjustment of line-of-sight and pantoscopic tilt together.

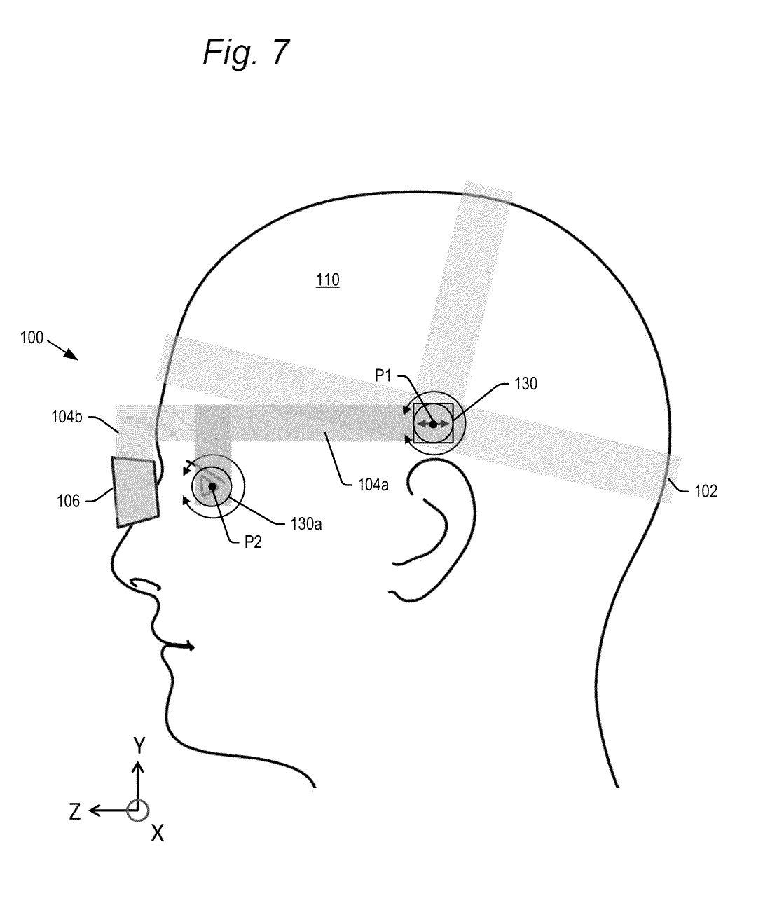

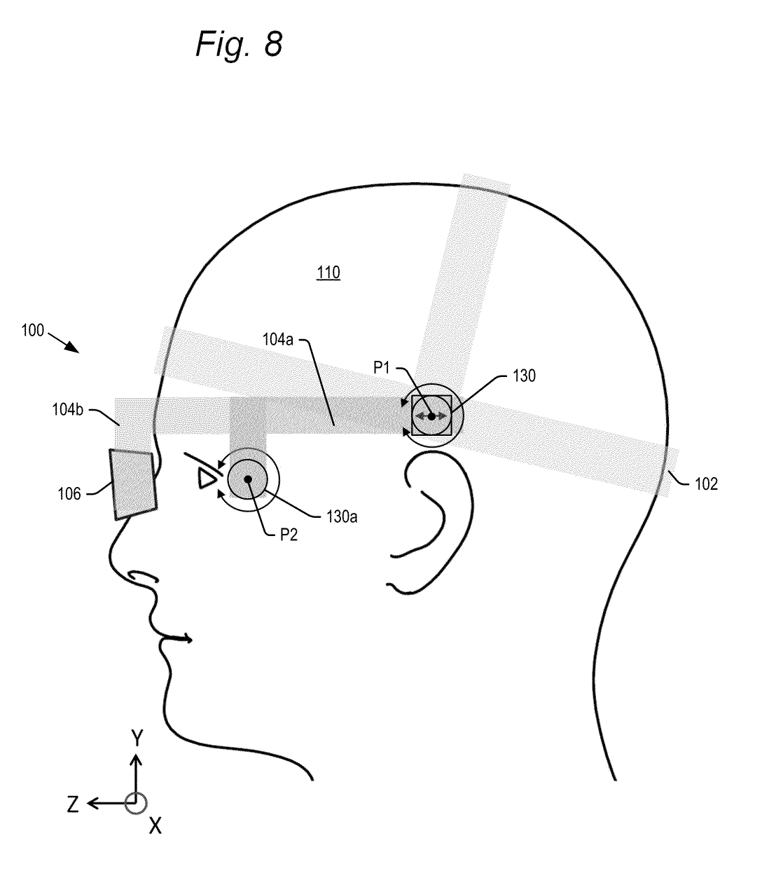

The embodiments of FIGS. 7 and 8 are structurally and operationally the same as the embodiment of FIG. 6, with the modification that the lengths of the horizontal portions of links 104a and 104b are varied. The horizontal portion of link 104a is shorter in FIG. 7 and shorter still in FIG. 8. The horizontal portion of link 104b is longer in FIG. 7 and longer still in FIG. 8. This has the effect of moving point P2 rearward (closer to ears of the wearer 110), and increasing the radius of adjustment of the optics 106 with respect to pivoting of link 104b about point P1.

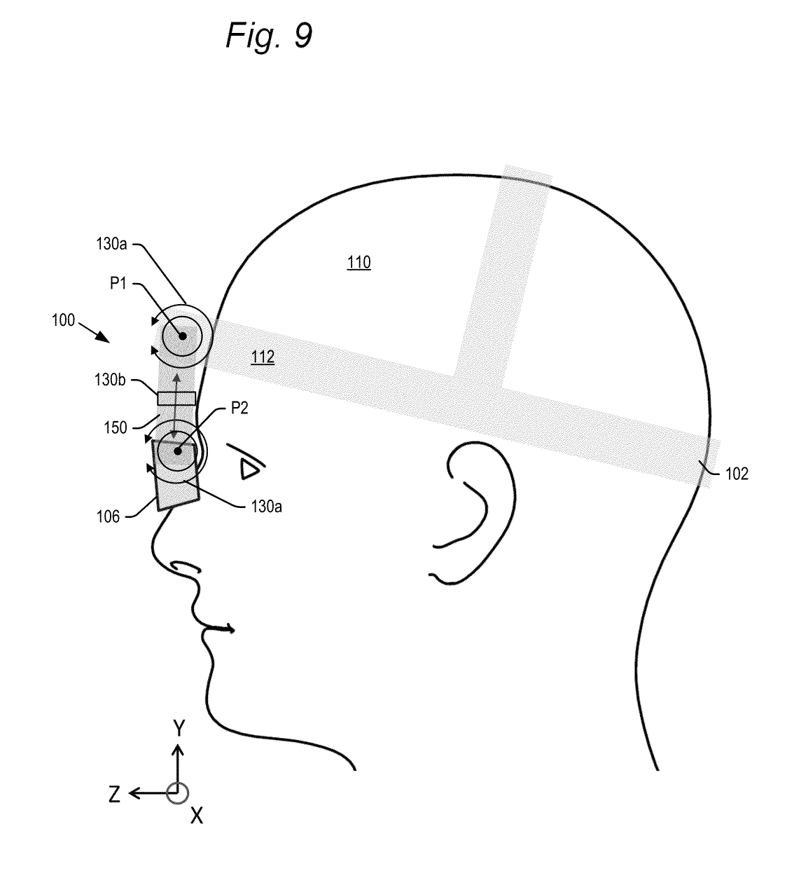

FIG. 9 shows a further embodiment of headset 100 including optics 106 mounted to headband 102 via a bracket 150 extending down from the crown loop 112 of the headband 102. Temple arms 104 may be omitted. There may be a pair of brackets 150, one supporting each of the optics 106, or there may be a single bracket across the front of the headband 102 which supports the pair of optics 106.

The bracket 150 may be pivotally mounted to the crown loop 112 at point P1 via a kinematic assembly 130a. The bracket 150 may include telescopic sections and a kinematic assembly 130b so that a length of the bracket can change in the y-z plane. In further embodiments, the bracket 150 may be of unitary construction (unchanging length) and may include a translating kinematic assembly 130b at a top or bottom of the bracket 150. A further kinematic assembly 130a pivotally mounts the optics 106 to the bracket 150 at point P2.

The headset 100 of FIG. 9 allows adjustment of the optics 106 with three degrees of freedom. The pair of kinematic assemblies 130a allow rotation of the optics 106 about two distinct x-axes (at points P1 and P2), and the kinematic assembly 130b further allows translation of the optics in the y-z plane. Rotation at point P1 the bracket 150 and optics 106. Translation at the kinematic assembly 130b will translate a lower portion of the bracket 150 and optics 106 with respect to an upper portion of the bracket. And pivoting at point P2 will pivot the optics 106 relative to the bracket 150. The kinematic assemblies and bracket of FIG. 9 allow adjustment of the line-of-sight, pantoscopic tilt and eye relief of optics 106.

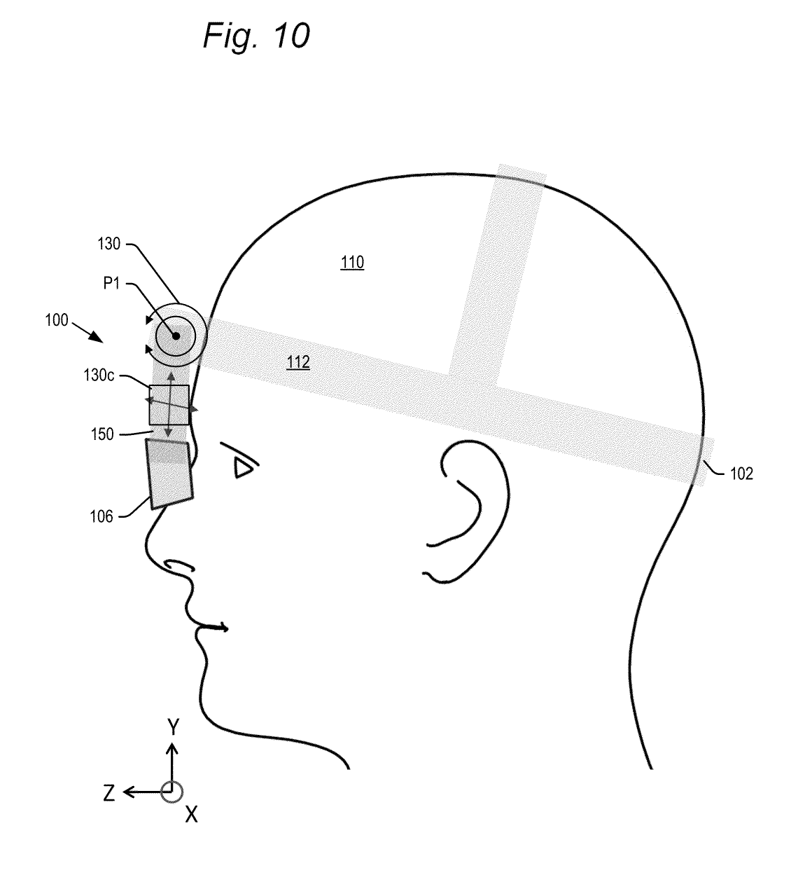

FIG. 10 shows a further embodiment of headset 100 including optics 106 mounted to headband 102 via the bracket 150. The bracket 150 may be pivotally mounted to the crown loop 112 at point P1 via a kinematic assembly 130a. FIG. 10 schematically shows a further embodiment of the kinematic assembly, referred to as the dual axis kinematic assembly 130c, capable of translating adjacent components in two orthogonal directions.

For example, the bracket 150 of FIG. 10 may include two sections, affixed to each other by the dual axis kinematic assembly 130c. The kinematic assembly 130c may include a longitudinal slide mechanism for translating the two sections of bracket 150 longitudinally (along the length of the bracket between the optics 106 and point P1) to shorten or lengthen the bracket 150. The longitudinal slide mechanism may in turn be affixed to a transverse slide mechanism for translating the two sections of bracket 150 transversely (orthogonal to the longitudinal direction of the bracket 150 in the y-z plane). The optics 106 may be fixedly mounted to the bottom section of the bracket 150. In further embodiments, the bracket may be a unitary construction (constant length), and the dual axis kinematic assembly 130c may be located at a top or bottom of the bracket 150.

The headset 100 of FIG. 9 allows adjustment of the optics 106 with three degrees of freedom. The kinematic assembly 130a allows rotation of the optics 106 about an x-axis (at point P1), and the dual axis kinematic assembly 130c further allows translation of the optics along the longitudinal length of bracket 150, or transverse to the longitudinal length of bracket 150, in the y-z plan. The kinematic assemblies and bracket of FIG. 10 allow adjustment of the line-of-sight, pantoscopic tilt and eye relief of optics 106.

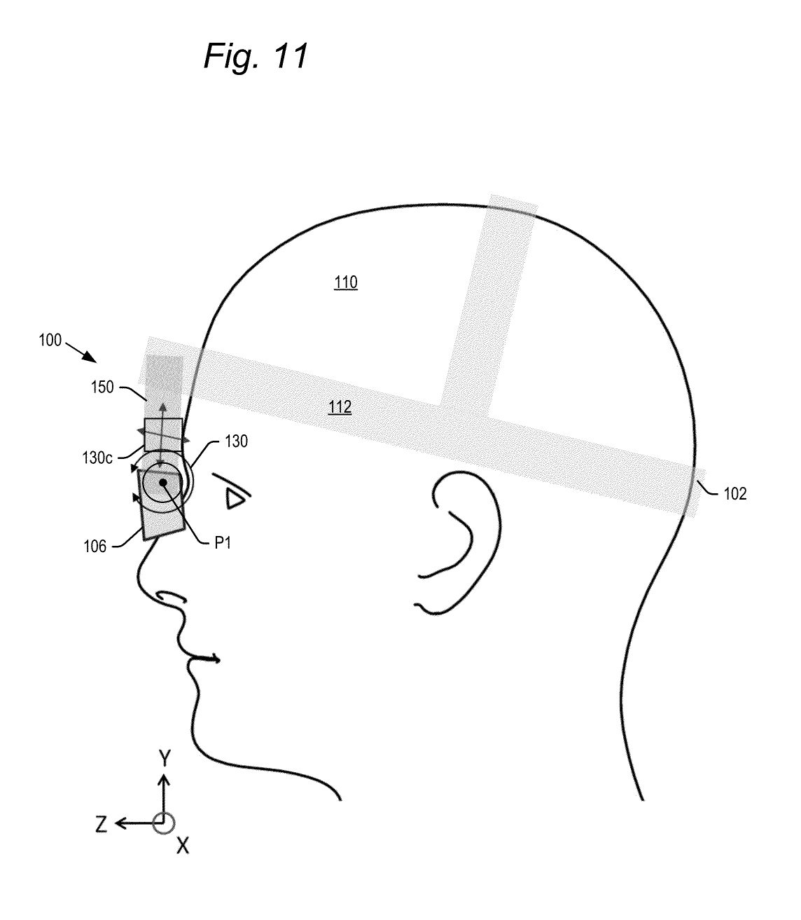

The embodiment of FIG. 11 is similar to the embodiment of FIG. 10, with the modification that the bracket 150 is fixedly mounted to the crown loop 112, and the optics 106 are pivotally mounted to the bracket 150.

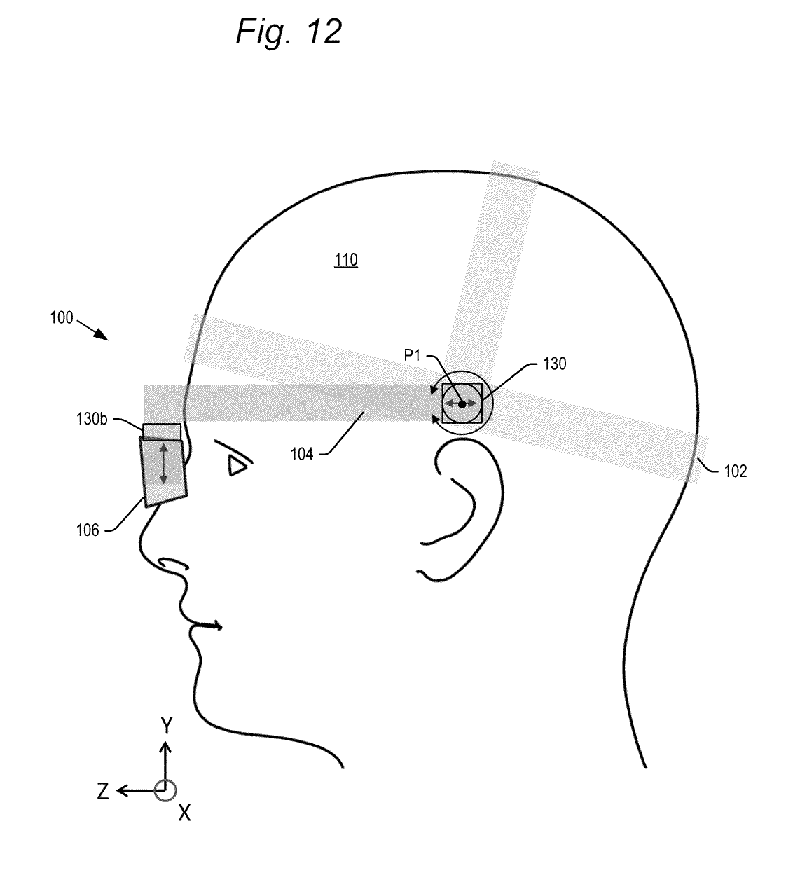

The embodiment of FIG. 12 is similar to the embodiment of FIG. 5, with the modification that, instead of pivotally mounting the optics 106 to the temple arms 104 via a kinematic assembly 130a as in FIG. 5, the optics 106 may be translationally mounted to the temple arms via a kinematic assembly 130b in FIG. 10.

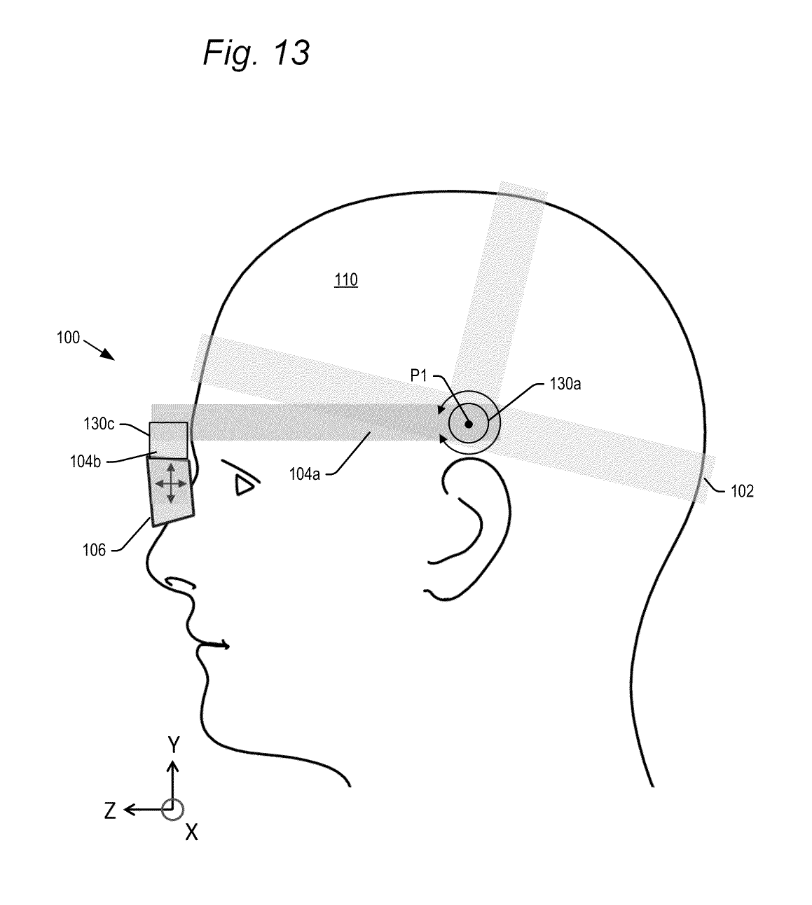

The embodiment of FIG. 13 is similar to the embodiment of FIG. 12, with the modification that the temple arm may be comprised of “L” shaped link 104a affixed to a short link 104b. The link 104b may be comprised of two sections affixed to each other via dual axis kinematic assembly 130c so that the bottom portion of the link 104b can translate longitudinally and traversely with respect to an upper portion of the link 104b in the y-z plane. The optics 106 may be fixedly mounted to an end of the lower portion of the link 104b. Alternatively, the temple arm may be an “L” shaped link of unitary construction, and the dual axis kinematic assembly 130c may be mounted at the end of the temple arm, between the optics 106 and the temple arm 104.

The headset 100 of FIG. 13 allows adjustment of the optics 106 with three degrees of freedom. The kinematic assembly 130a allows rotation of the optics 106 about an x-axis (at point P1), and the dual axis kinematic assembly 130c further allows translation of the optics along a longitudinal length of link 104b, and transverse to the longitudinal length of link 104b, in the y-z plan. The kinematic assemblies and links of FIG. 13 allow adjustment of the line-of-sight, pantoscopic tilt and eye relief of optics 106.

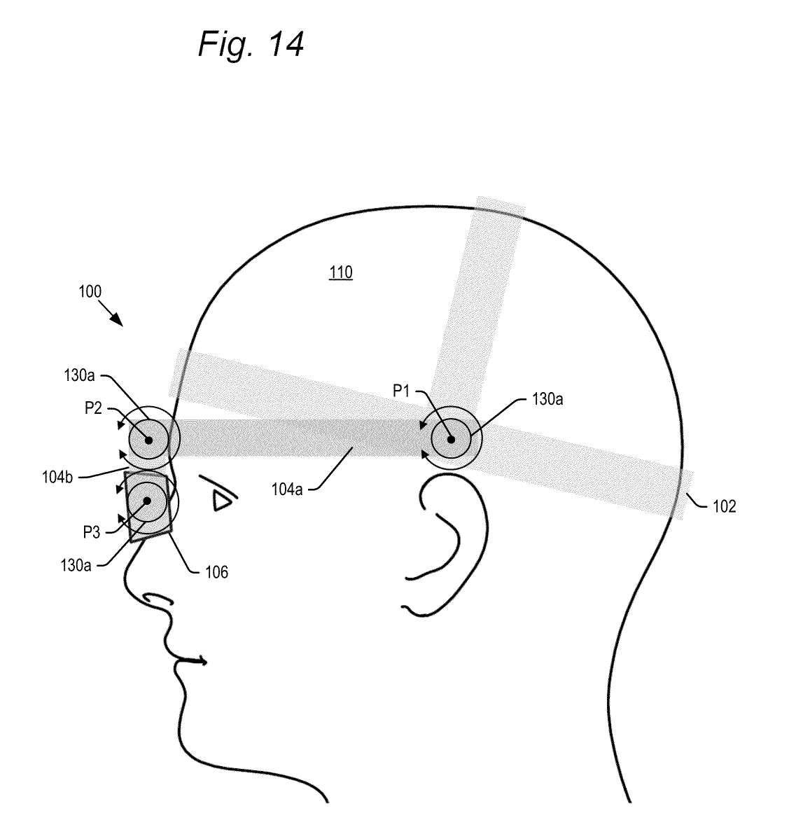

FIG. 14 shows a further embodiment of headset 100 including optics 106 mounted to headband 102 via temple arms 104 each including links 104a, 104b and three kinematic assemblies 130a. In this embodiment, a link 104a is a linear link pivotally mounted by kinematic assembly 130a to the headband 102 at a point P1. A second kinematic assembly 130a pivotally mounts the link 104b to the link 104a at point P2. A third kinematic assembly 130a pivotally mounts optics 106 to the link 104a.

The headset 100 of FIG. 14 allows adjustment of the optics 106 with three degrees of freedom. The first kinematic assembly allows rotation of links 104a, 104b and optics 106 with respect to the headband 102. The second kinematic assembly allows rotation of link 104b and optics 106 with respect to link 104a. And the third kinematic link allows rotation of the optics 106 with respect to link 104b. The kinematic assemblies and links of the temple arms 104 in FIG. 14 allow adjustment of the line-of-sight, pantoscopic tilt and eye relief of optics 106.

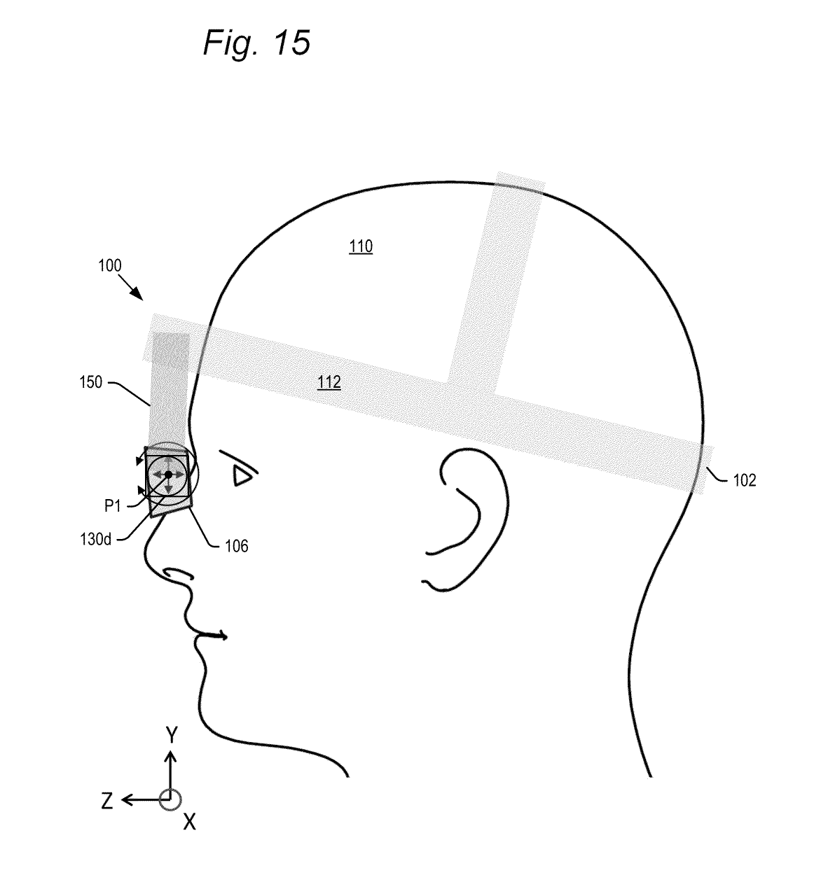

FIG. 15 shows a further embodiment of headset 100 including optics 106 mounted to headband 102 via a bracket 150 and a further embodiment of a kinematic assembly 130d. Bracket 150 may be fixedly mounted to a front portion of crown loop 112. Kinematic assembly 130d may be mounted between the bracket 150 and optics 106, and allows optics 106 to translate longitudinally along the length of bracket 150 (between it mounting point on crown loop 112 and its opposed end), translate transversely to the longitudinal direction, and pivot about point P1. In an example, the optics 106 may be pivotally mounted to a pivot assembly 134, which is in turn mounted on a dual axis kinematic assembly as described above.

The kinematic assembly 130d of FIG. 15 allows the optics 106 to be adjusted with three degrees of freedom with respect to bracket 150 and allows adjustment of the line-of-sight, pantoscopic tilt and eye relief of optics 106. The kinematic assembly 130d may be moved to the opposite end of bracket 150 to pivotally and translationally mount the bracket 150 to the crown loop 112. Further, the bracket of FIG. 15 may alternatively be replaced by a temple arm 104.

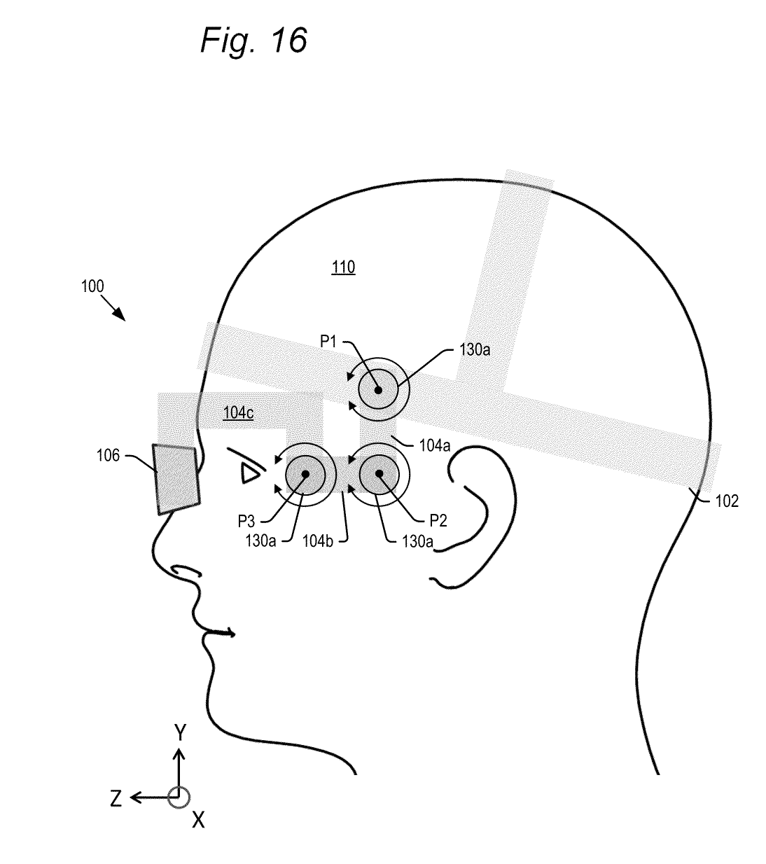

FIG. 16 shows a further embodiment of headset 100 including optics 106 mounted to headband 102 via temple arms 104 each including links 104a, 104b, 104c and three kinematic assemblies 130a. In this embodiment, link 104a may be pivotally mounted to the headband 102 by a first kinematic assembly 130a at point P1. Links 104a and 104b may be linear links pivotally mounted to each other by a second kinematic link at point P2. Link 104c may be an upside down “U” shaped link pivotally mounted to link 104b by a third kinematic link at point P3. The optics 106 may be fixedly mounted on the link 104c.

The link 104b may lie in different y-z planes (into and out of the page of FIG. 16) than links 104a, 104c so that each link may freely pivot with respect to the other links without conflict. More than three links, pivotally and/or translationally mounted to each other, may be provided in a temple arm 104 in further embodiments.

The headset 100 of FIG. 16 allows adjustment of the optics 106 with three degrees of freedom. The kinematic assemblies 130a allow rotation of the optics 106 about three distinct x-axes (at points P1, P2 and P3) The kinematic assemblies and links of the temple arms 104 in FIG. 16 allow adjustment of the line-of-sight, pantoscopic tilt and eye relief of optics 106.

It is understood that the above-described figures provide non-limiting examples systems for adjustably supporting optics or other head-worn devices on a headband. It is within the scope of the present technology to combine arrangement of one or more links and/or kinematic assemblies from one of the embodiments described above into other embodiments described above.

In any of the embodiments described above, a wearer 110 may adjust the optics 106 by grasping the optics 106 and moving them as desired. Such movement may cause pivoting and/or translation of one or more of the kinematic assemblies within that embodiment. A user may alternative grip and move an “upstream” link or kinematic assembly (i.e., a link or kinematic assembly closer to a mounting point of the temple arm 104 or bracket 150 to the headband 102 than optics 106). In this instance, one or more of the kinematic assemblies upstream of the gripping point may pivot and/or translate.

As noted above, movement of the optics 106 may simultaneously adjust one or more of the optical properties simultaneously. A user may make adjustments to the optics 106 (or upstream portions) to converge on a solution where the line-of-sight, pantoscopic tilt and eye relief are all optimized to the use's preference.

In summary, in a first example, the present technology relates to a headset, comprising: a headband; a head-worn device for being positioned adjacent a wearer's eyes, the head-worn device having optical properties including line-of-sight, pantoscopic tilt and eye relief; and one or more links and one or more kinematic assemblies supporting the head-worn device at one side of the wearer's head adjacent the wearer's eyes and adjusting at least two of the optical properties upon manually grasping and moving one of the head-worn device, a link of the one or more links and a kinematic assembly of the one or more kinematic assemblies, the one or more kinematic assemblies mounted at at least one junction between the headband and a link of the one or more links, two links where the one or more links comprise at least two links, and a link of the plurality of links and the head-worn device, and the one or more kinematic assemblies allowing at least one of translation and rotation at the at least one junction.

In a further example, the present technology relates to a headset having a frame of reference when worn where an x-axis is oriented from a left side to a right side of a head of a wearer, a z-axis orthogonal to the x-axis is oriented toward and away from a face of the wearer, and a y-axis orthogonal to the x-axis and z-axis, the headset comprising: a headband; optics for being positioned adjacent a user's eyes, the optics having optical properties including line-of-sight, pantoscopic tilt and eye relief; and a link coupled to the headband at a first end of the link, and coupled to the optics at one side of a wearer's head at a second end of the link; and a kinematic assembly attached to one of the first and second ends of the link to couple the link to one of the optics and headband, the kinematic assembly adjusting two of the optical properties upon manually grasping and moving one of the optics, the link and the kinematic assembly, the kinematic assembly allowing translation of the optics in an y-z plane of the frame of reference and rotation of the optics about the x-axis of the frame of reference.

In a further example, the present technology relates to a headset having a frame of reference when worn where an x-axis is oriented from a left side to a right side of a head of a wearer, a z-axis orthogonal to the x-axis is oriented toward and away from a face of the wearer, and a y-axis orthogonal to the x-axis and z-axis, the headset comprising: a headband; optics for being positioned adjacent a wearer's eyes, the optics having optical properties including line-of-sight, pantoscopic tilt and eye relief; a plurality of links together supporting the optics on the headband at one side of a user's head; and a plurality of kinematic assemblies adjusting line-of-sight, pantoscopic tilt and eye relief upon manually grasping and moving one of the head-worn device, a link of the one or more links and a kinematic assembly of the one or more kinematic assemblies, the one or more kinematic assemblies mounted at at least two junctions between the headband and a link of the plurality of links, adjacent links of the plurality of links, and a link of the plurality of links and the optics, and the plurality of kinematic assemblies allowing translation of the optics in an y-z plane of the frame of reference, and rotation of the optics about at least one x-axis of the frame of reference.

In another example, the present technology relates to a headset including means for supporting optics adjacent eyes of user, and means for adjusting line-of-sight, pantoscopic tilt and eye relief upon manually grasping and moving one of the optics, support means and adjustment means.

Although the subject matter has been described in language specific to structural features and/or methodological acts, it is to be understood that the subject matter defined in the appended claims is not necessarily limited to the specific features or acts described above. The specific features and acts described above are disclosed as example forms of implementing the claims.

We claim:

1. A headset, comprising:
a headband;
a head-worn device for being positioned adjacent a wearer's eyes, the head-worn device having optical properties including line-of-sight, pantoscopic tilt and eye relief; and
one or more links and one or more kinematic assemblies supporting the head-worn device at one side of the wearer's head adjacent the wearer's eyes and adjusting at least two of the optical properties upon manually grasping and moving one of the head-worn device, a link of the one or more links and a kinematic assembly of the one or more kinematic assemblies,
the one or more kinematic assemblies mounted at at least one junction between the headband and a link of the one or more links, two links where the one or more links comprise at least two links, and a link of the plurality of links and the head-worn device, and
the one or more kinematic assemblies allowing at least one of translation and rotation at the at least one junction.

2. The headset of claim 1, the headband comprising a crown loop adapted to extend around the crown of a head, a link of the one or more links connected to the crown loop via a kinematic assembly of the one or more kinematic assemblies.

3. The headset of claim 1, the headband comprising a crown loop adapted to extend around the crown of a head, and an overhead loop affixed to the crown loop and adapted to extend over a top of a head, a link of the one or more links connected to the crown loop via a kinematic assembly of the one or more kinematic assemblies.

4. The headset of claim 1, wherein two of the optical properties are adjusted upon manually grasping and moving one of the head-worn device, a link of the one or more links and a kinematic assembly of the one or more kinematic assemblies.

5. The headset of claim 4, wherein the one or more links is a single link, and the one or more kinematic assemblies is a single kinematic assembly capable of both rotation and translation at the junction.

6. The headset of claim 5, wherein the junction is between the headband and the single link.

7. The headset of claim 1, wherein line-of-sight, pantoscopic tilt and eye relief are adjusted upon manually grasping and moving one of the head-worn device, a link of the one or more links and a kinematic assembly of the one or more kinematic assemblies.

8. The headset of claim 7, wherein the one or more kinematic assemblies are first and second kinematic assemblies.

9. The headset of claim 8, wherein the first kinematic assembly rotates at a first junction of the one or more junctions and does not translate, and wherein the second kinematic assembly translates at a second junction of the one or more junctions.

10. The headset of claim 8, wherein the first kinematic assembly rotates and translates at a first junction of the one or more junctions.

11. The headset of claim 10, wherein the first kinematic assembly translates about two orthogonal axes.

12. A headset having a frame of reference when worn where an x-axis is oriented from a left side to a right side of a head of a wearer, a z-axis orthogonal to the x-axis is oriented toward and away from a face of the wearer, and a y-axis orthogonal to the x-axis and z-axis, the headset comprising:
a headband;
optics for being positioned adjacent a user's eyes, the optics having optical properties including line-of-sight, pantoscopic tilt and eye relief; and
a link coupled to the headband at a first end of the link, and coupled to the optics at one side of a wearer's head at a second end of the link; and
a kinematic assembly attached to one of the first and second ends of the link to couple the link to one of the optics and headband, the kinematic assembly adjusting two of the optical properties upon manually grasping and moving one of the optics, the link and the kinematic assembly, the kinematic assembly allowing translation of the optics in an y-z plane of the frame of reference and rotation of the optics about the x-axis of the frame of reference.

13. The headset of claim 12, wherein the kinematic assembly is attached to the first end of the link to pivotally and translationally affix the optics and the link to the headband.

14. The headset of claim 13, wherein the optics are fixedly mounted to the second end of the link.

15. The headset of claim 12, wherein the kinematic assembly is attached to the second end of the link to pivotally and translationally affix the optics to the link and the headband.

16. The headset of claim 15, wherein the link is fixedly mounted to the headband at the second end of the link.

17. A headset having a frame of reference when worn where an x-axis is oriented from a left side to a right side of a head of a wearer, a z-axis orthogonal to the x-axis is oriented toward and away from a face of the wearer, and a y-axis orthogonal to the x-axis and z-axis, the headset comprising:
a headband;
optics for being positioned adjacent a wearer's eyes, the optics having optical properties including line-of-sight, pantoscopic tilt and eye relief;
a plurality of links together supporting the optics on the headband at one side of a user's head; and
a plurality of kinematic assemblies adjusting line-of-sight, pantoscopic tilt and eye relief upon manually grasping and moving one of the head-worn device, a link of the one or more links and a kinematic assembly of the one or more kinematic assemblies,
the one or more kinematic assemblies mounted at at least two junctions between the headband and a link of the plurality of links, adjacent links of the plurality of links, and a link of the plurality of links and the optics, and
the plurality of kinematic assemblies allowing translation of the optics in an y-z plane of the frame of reference, and rotation of the optics about at least one x-axis of the frame of reference.

18. The headset of claim 17, wherein the plurality of links are first and second links and the plurality of kinematic assemblies are first and second kinematic assemblies, the first kinematic assembly affixed between the first and second links and the second kinematic assembly affixed between one of the first and second links and one of the optics and head band.

19. The headset of claim 17, the first kinematic assembly pivotally affixing the first and second links, the first kinematic assembly positioned along the z-axis at eye level when the headset is worn by a wearer.

20. The headset of claim 19, wherein the first link is “U” shaped, and the second link is “L” shaped.
